(19) United States
(12) Patent Application Publication
(10) Pub. No.: US 2021/0167468 A1
(43) Pub. Date: Jun. 3, 2021

(54) POWER STORAGE COMPONENT MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); TOYOTA JIDOSHA KABUSHIKI KAISHA, Aichi (JP)

(72) Inventors: Nobuyuki MATSUMURA, Mie (JP); Yusuke SUZUKI, Aichi (JP); Isamu HAMAMOTO, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); TOYOTA JIDOSHA KABUSHIKI KAISHA, Aichi (JP)

(21) Appl. No.: 16/973,613

(22) PCT Filed: May 31, 2019
(86) PCT No.: PCT/JP2019/021701

§ 371 Date: Dec. 9, 2020

(30) Foreign Application Priority Data
Jun. 13, 2018 (JP) 2018-112961

(51) Int. Cl. H01M 50/505; H01M 50/204; H01M 50/543

(52) U.S. Cl. CPC H01M 50/505; H01M 2220/20; H01M 50/543; H01M 50/204

(57) ABSTRACT

A power storage module includes a first power storage component, a second power storage component, and a bus bar. The first power storage component and the second power storage component are disposed with electrodes facing up. The bus bar connects the electrodes together. The first power storage component includes a positioning boss projecting upward from the electrode. The bus bar includes a through hole opening in a top-bottom direction and through which the positioning boss is passed. The bus bar includes a support projection projecting downward. The support projection is disposed on the electrode of the first power storage component. A joint is disposed between the support projection and the electrode of the first power storage component to electrically connect the support projection to the electrode. The joint and the positioning boss are aligned when viewed from above.

### TECHNICAL FIELD

The technology disclosed herein relates to a power storage component module, specifically to a structure for connecting power storage component to one another.

### BACKGROUND ART

An example of a power storage component module that includes power storage components disclosed in Patent Document 1 has been known. In the power storage component module, each of battery packs includes electric terminals and bus bars. The electric terminals include upper surfaces that are flat and defined as electrode surfaces. The bus bars formed from plates. Each bus bar has a rectangular shape. The battery packs are arranged such that adjacent electric terminals have opposite polarities. A wire module is attached to surfaces on which the electric terminals are disposed. The bus bars and the electric terminals disposed inside the wire module are electrically connected by laser welding portions of the bus bars placed over the electrical terminals to the electric terminals.

### RELATED ART DOCUMENT

### Patent Document

[Patent Document 1] Japanese Unexamined Patent Application Publication No. 2016-100248

### SUMMARY OF THE INVENTION

### Problem to be Solved by the Invention

According to the technology, the electric terminals must have surface contact with the bus bars. If vertical positions of the surfaces of the adjacent battery packs on which the electric terminals are disposed are different from each other due to dimensional differences within tolerance, the bus bars need to be forcedly brought into surface contact with the electric terminals for joint. This may result in plastic deformation of the bus bars.

### Means for Solving the Problem

A power storage component module according to the technology described herein includes a first power storage component, a second power storage component, and a bus bar. The first power storage component is disposed with an electrode of the first power storage component facing up. The second power storage component is disposed with an electrode of the second power storage component facing up. The bus bar connects the first power storage component and the second power storage component together. The first power storage component includes a positioning boss projecting upward from the electrode of the first power storage component. The bus bar includes: a through hole opening in a top-bottom direction and through which the positioning boss is passed; and a support projection projecting downward, the support projection being disposed on the electrode of the first power storage component. The support projection is electrically connected to the electrode of the first power storage component via a joint between the support projection and the electrode. The joint and the positioning boss are aligned when viewed from above.

According to the configuration, the bus bar can be positioned relative to the positioning boss by passing the positioning boss through the through hole and placing the support projection on the electrodes. When the support projection is place on the electrode, the bus bar tilts due to its own weight and contacts the electrodes. According to the configuration, even if a difference in vertical position is present between the electrode of the first power storage component and the electrode of the second power storage component, the bus bar is disposed on the electrodes at an angle regardless of the difference. Therefore, the bus bar is less likely to deform and thus the durability of the bus bar is ensured. Further, the joint and the positioning boss are aligned when viewed from above, that is, a position at which the joint is formed can be determined based on the positioning boss.

Preferable embodiments of the technology described herein may have the following configurations.

(1) The support projection may include a distal end that is aligned with the positioning boss. The electrode may include a holding section on which the distal end is disposed. The joint may include the distal end and the holding section.

According to the configuration, to form the joint, positions of the distal end and the holding section are determined based on the positioning boss and a portion in which the joint is to be formed is defined based on the positions.

(2) The distal end may have a linear shape. The bus bar may include a V-shaped groove in an upper surface of the bus bar over the supporting projection. The V-shaped groove may be recessed to form a V shape when viewed from a side. The V-shaped groove may include a groove bottom having a linear shape. The groove bottom may overlap the distal end in the top-bottom direction.

According to the configuration, the position of the distal end can be determined from above based on detection of the groove bottom from above. Therefore, the portion in which the joint is to be formed can be determined as a linear portion, that is, an area in which joining is performed can be reduced. Further, the V-shaped groove and the support projection are formed by bending the bus bar so that the distal end projects downward. This reduces a process cost.

(3) The support projection may have a spherical dome shape. The support projection may include a spherical dome recess having a spherical shape in an upper surface of the bus bar. The spherical dome recess may be concentric with the support projection.

According to the configuration, the lowest section of the support projection is the distal end. Further, the distal end and the lowest section of the spherical dome recess are aligned in the top-bottom direction. Therefore, a position of the lowest section on the upper surface side can be determined as a position of the distal end. From the determination, the area in which joining is performed can be determined.

### Advantageous Effects of Invention

According to the technology disclosed herein, durability of the bus bar improves.

### BRIEF DESCRIPTION OF THE DRAWINGS

FIG. 1 is a perspective view illustrating a power storage component module according to a first embodiment.

FIG. 2 is a perspective view illustrating a power storage component.

FIG. 3 is a side view illustrating a power storage component module.

FIG. 4 is a perspective view illustrating a bus bar.

FIG. 5 is a top view illustrating the bus bar.

FIG. 6 is a side view illustrating the bus bar.

FIG. 7 is a top view illustrating the power storage component module.

FIG. 8 is a cross-sectional view along line A-A in FIG. 7.

FIG. 9 is a perspective view illustrating a bus bar according to a second embodiment.

FIG. 10 is a side view illustrating the bus bar.

FIG. 11 is a rear view illustrating a power storage component module.

FIG. 12 is a top view illustrating the power storage component module.

FIG. 13 is a side view illustrating the power storage component module.

FIG. 14 is a side view illustrating a power storage component module according to a third embodiment.

FIG. 15 is a perspective view illustrating the power storage component module.

FIG. 16 is a top view illustrating the power storage component module.

### MODES FOR CARRYING OUT THE INVENTION

### First Embodiment

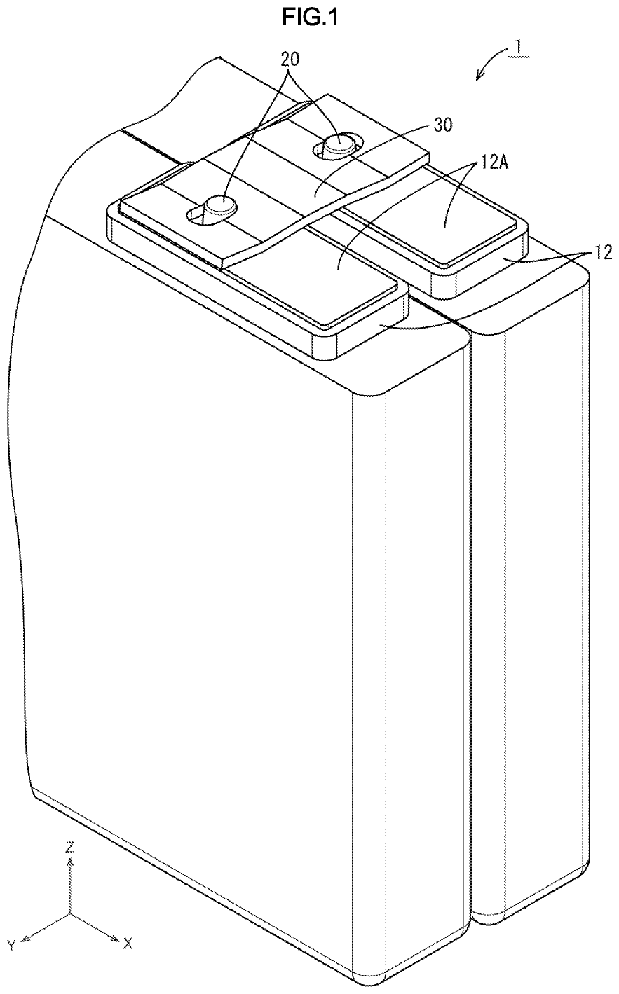

A first embodiment will be described with reference to FIGS. 1 to 8.

This embodiment relates to a power storage component module 1 to be installed in a vehicle. As illustrated in FIG. 1, the power storage component module 1 includes multiple (two in this embodiment) power storage components 10 and 110 and a bus bar 30 that connects the power storage component 10 to the power storage component 110. The embodiment will be described with reference to a Z arrow, a Y arrow, and an X arrow that point an upper side, a front side, and a left side, respectively.

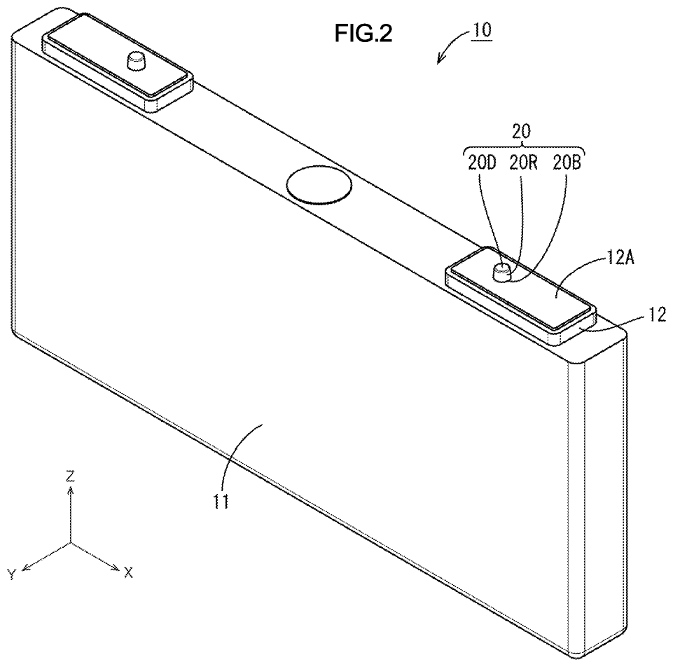

As illustrated in FIG. 2, the first power storage component 10 of the power storage components 10 and 110 includes a component body 11 and an electrode 12. The component body 11 has a box shape that is flat in a front-rear direction. The electrode 12 is disposed on an upper surface of the component body 11. An upper surface 12A of the electrode 12 is a flat surface. The upper surface 12A of the electrode 12 may be referred to as an electrode surface 12A hereinafter.

The first power storage component 10 includes a positioning boss 20 for positioning the bus bar 30 relative to the electrode 12. The positioning boss 20 is made of a conductive metal material. The positioning boss 20 protrudes upward from the electrode 12. The positioning boss 20 includes a base end 20B and an upper end 20D. The base end 20B has a round shape in a top view. The upper end 20D has a round shape that is concentric with the base end 20B. The positioning boss 20 has a truncated cone shape with a diameter that slightly decreases from the base end 20B toward the upper end 20D. The second power storage component 110 includes an electrode 12 that has an opposite polarity from a polarity of the electrode of the first power storage component 10. Other configurations of the second power storage component 110 are similar to those of the first power storage component 10 and thus will not be described.

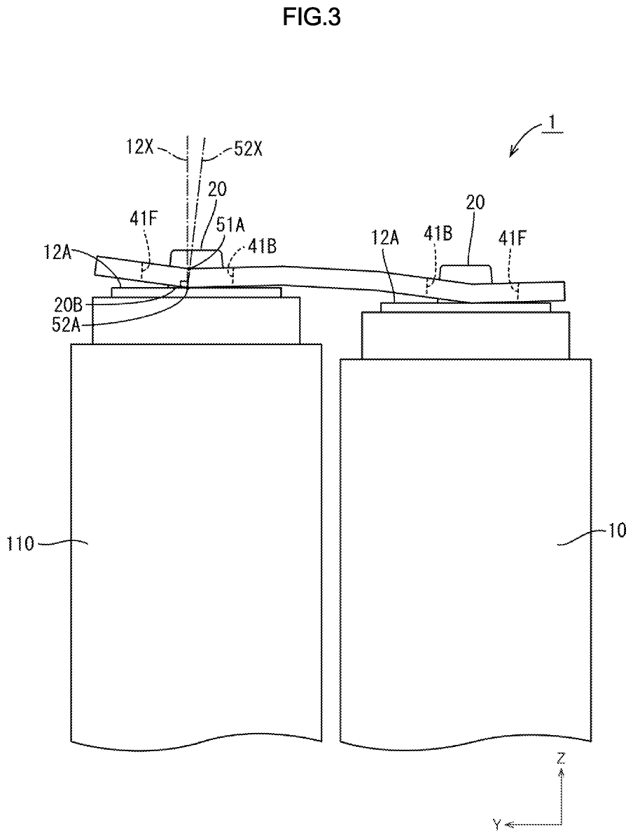

As illustrated in FIG. 1, the first power storage component 10 and the second power storage component 110 are disposed inside a module case, which is not illustrated, with the electrode surfaces 12A arranged in the front-rear direction. The electrode surface 12A of the first power storage component 10 and an electrode surface 12A of the second power storage component 110 may be at different vertical positions because of positioning errors that are allowed within the dimensional tolerance of the first storage component 10, the second power storage component 110, and the module case. In this embodiment, as illustrated in FIG. 3, the electrode surface 12A of the first power storage component 10 is positioned lower than the electrode surface 12A of the second power storage component 110. The positioning errors of the first power storage component 10 and the second power storage component 110 in the top-bottom direction are assumed to be the maximum.

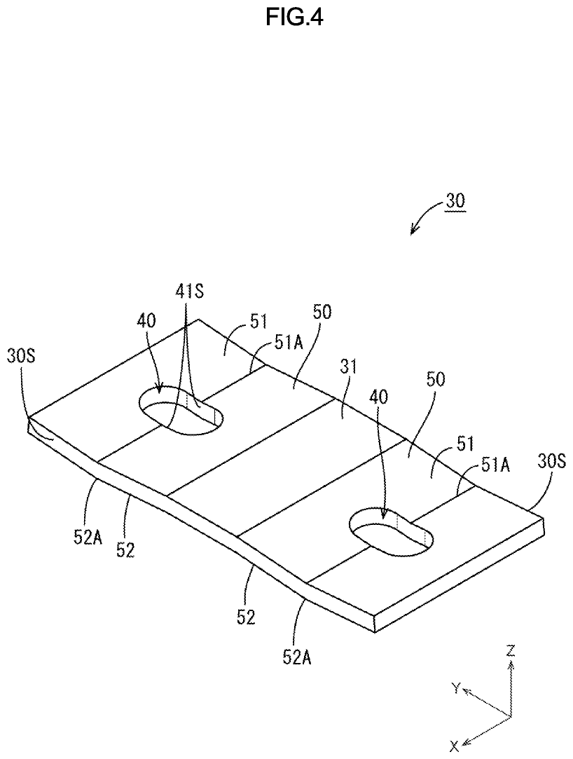

The bus bar 30 is made of a conductive metal material such as copper and aluminum. As illustrated in FIGS. 4 and 5, the bus bar 30 has a rectangular plate shape in a top view. The bus bar 30 includes two through holes 40 that open in a direction normal to a plate surface of the bus bar 30.

Specifically, as illustrated in FIG. 5, each through hole 40 has an oval shape that is elongated in the front-rear direction. A hole edge 41 includes an edge-side arc section 41F, a center-side arc section 41B, and right and left linear hole edge sections 41S. The right and the left linear hole edge sections 41S connect right and left rear edges of the edge-side arc section 41F to right and left front edges of the center-side arc section 41B. The linear hole edge sections 41S linearly extend to be parallel to each other. A distance between the linear hole edge sections 41S in the right-left direction (that is, a maximum width of the through hole 40) is defined equal to or slightly greater than a diameter of the base end 20B of the positioning boss 20.

As illustrated in FIG. 4, the bus bar 30 includes a connecting portion 31 and bent portions 50. The connecting portion 31 is located in the middle with respect to the front-rear direction. The bent portions 50 are located on the front side and the rear side, respectively. Each bent portion 50 is bent to form a shallow V shape in a side view.

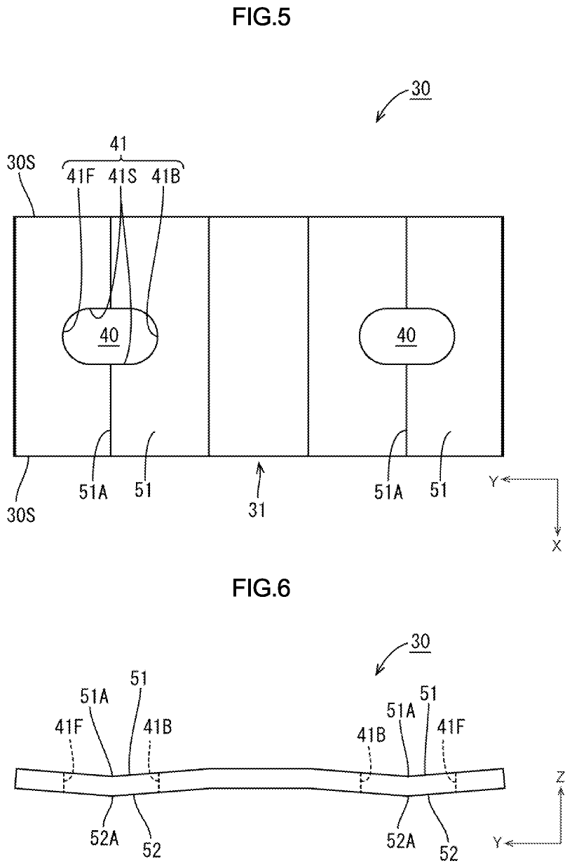

Each bent portion 50 includes a top surface that is recessed downward to form V-shaped grooves 51. The V-shaped grooves 51 include groove bottoms 51A that linearly extends in the right-left direction from the middle points of the corresponding linear hole edge sections 41S with respect to the front-rear direction to right and left side edges 30S of the bus bar 30, respectively. Each bent portion 50 includes a lower surface that projects downward to form elongated projections that are defined as support projections 52. The support projections 52 include upper ends 20D that extend in the right-left direction. As illustrated in FIG. 6, when the bus bar 30 is in a horizontal position with a middle portion of the bus bar 30 leveled, the groove bottom 51A of each V-shaped groove 51 is over a distal end 52A of the corresponding support projection 52.

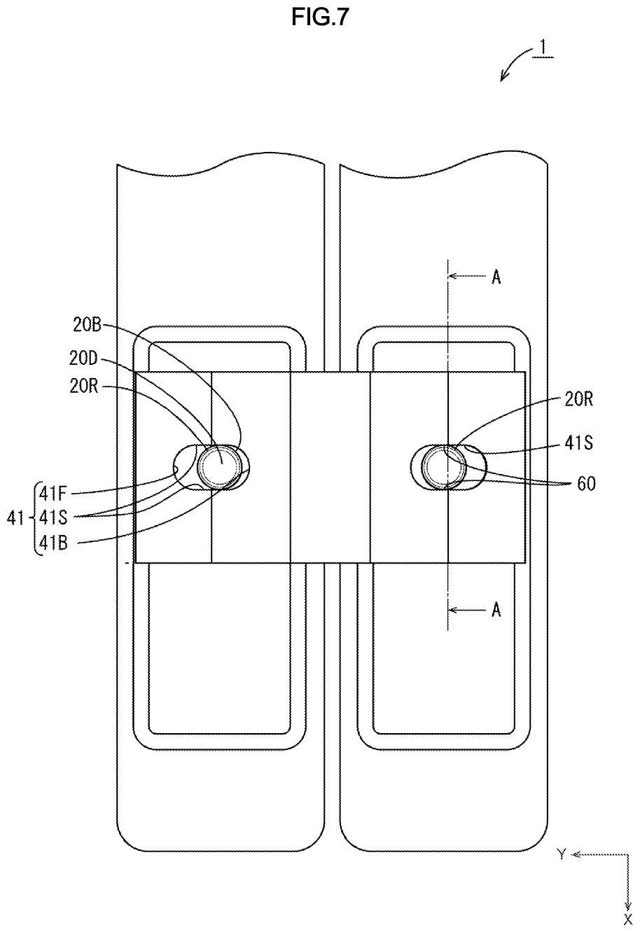

As illustrated in FIG. 3, when the power storage components 10 and 110 are connected to each other with the bus bar 30, the positioning bosses 20 are passed through the respective through holes 40 and the support projections 52 are disposed on the electrode surfaces 12A, respectively. The bus bar 30 is positioned relative to the electrodes 12. The arcs of each end-side arc section 41F and each center-side arc section 41B and the length of each liner hole edge section 41S are defined such that the arc sections 41F and 41B do not contact the periphery 20R of the corresponding positioning boss 20 even if the positioning error in the top-bottom direction between the first power storage component 10 and the second power storage component 110 is at the minimum or the maximum. As illustrated in FIG. 7, the end-side arc section 41F and the center-side arc section 41B of the hole edge 41 of each through hole 40 are separated from the periphery 20R of the corresponding positioning boss 20 in the front-rear direction and slightly separated from the periphery 20R in the right-left direction.

The electrode 12 of the first power storage component 10 and the electrode surface 12A of the second power storage component 110 are at different vertical positions as described below. Therefore, as illustrated in FIG. 3, the bus bar 30 disposed on the electrode surfaces 12A is sloped downward toward the rear. As illustrated in FIG. 3, a dimension of each support projection 52 that projects from the bus bar 30 is defined such that the bus bar 30 is positioned at a vertical position at which the bus bar 30 does not contact the component body 11 and the electrodes 12 of the first power storage component 10 and a component body 11 and the electrode 12 of the second power storage component 110.

In the situation described above, the power storage components 10 and 110 are displaced from each other in the vertical direction. In this embodiment, each positioning boss 20 has a truncated cone shape and each through hole 40 has the oval shape that is elongated in the arrangement direction of the through holes 40. Therefore, deviations of the power storage components 10 and 110 in the right-left direction and the front-rear direction are allowed.

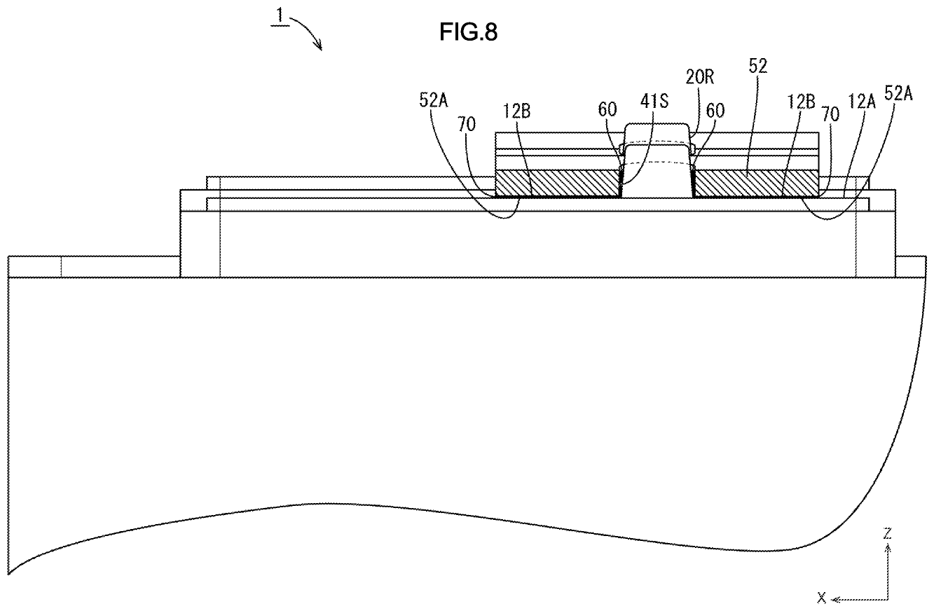

As illustrated in FIGS. 7 and 8, supplemental joints 60 are formed between the linear hole edge sections 41S of the hole edges 41 and the peripheries 20R of the positioning bosses 20. Two supplemental joints 60 are provided for each positioning boss 20 to electrically connect the linear hole edge sections 41S to the periphery 20R of the positioning boss 20. Two supplemental joints 60 are disposed on a straight line extending in the right-left direction with the corresponding positioning boss 20 between the supplemental joints 60. In this embodiment, each supplemental joint 60 is formed by melting surfaces of the corresponding linear hole edge section 41S and the periphery 20R of the corresponding positioning boss 20 through laser welding.

As illustrated in FIG. 8, joints 70 are provided between the electrode surfaces 12A and the upper ends 20D of two support projections 52 on the electrode surfaces 12A. Two joints 70 are disposed on a straight line extending in the right-left direction with the corresponding positioning boss 20 between the joints 70. In this embodiment, each joint 70 is formed by melting surfaces of a holding section 12B of the corresponding electrode surface 12A on which a distal end 52A is disposed and the distal end 52A of the corresponding support projection 52 through laser welding.

Next, an example of procedure of forming the joints 70 will be described. First, the bus bar 30 is disposed on the electrode surfaces 12A of the first power storage component 10 and the second power storage component 110 held in a module case, which is not illustrated. When the positioning bosses 20 are passed through the respective through holes 40, the bus bar 30 is sloped downward toward the rear with its own weight. According to the configuration, the distal ends 52A of the support projections 52 are disposed on the electrode surfaces 12A with the distal ends 52A in contact with the electrode surfaces 12A for entire dimensions in the right-left direction regardless of a difference in vertical position between the electrode surfaces 12A.

Next, positions of the distal ends 52A of the support projections 52 are determined. First, an existing area in which the upper ends 20D of the positioning bosses 20 are present is detected by a detector, which is not illustrated. Then, an area obtained by expanding the existing area in the right-left direction by the width of the bus bar is defined as a possible existing area in which the distal ends 52A may be present. Positions of the groove bottoms 51A of the V-shaped grooves 51 in the possible existing area are detected and determined as positions of the distal ends 52A. Areas that extend in the right-left direction to pass the positions are determined as laser application areas.

If the vertical positions of the electrode surfaces 12A are different from each other, axes 52X of the support projections 52 are slightly tilted toward the rear relative to normal lines 12X (see FIG. 3). The position of each distal end 52A with respect to the front-rear direction and the position of the corresponding groove bottom 51A with respect to the front-rear direction are slightly different from each other. With consideration of the difference, it is preferable that the laser application areas have margins in the front-rear direction.

The laser application areas are linearly scanned with laser spotlight, which is not illustrated, in the right-left direction from the top. As described earlier, the distal ends 52A of the support projections 52 contact the electrode surfaces 12A for entire dimensions in the right-left direction because of the weight of the bus bar 30. Therefore, it is not necessary to press the distal ends 52A against the electrode surfaces 12A and thus the bus bar 30 is less likely to be deformed during forming of the joints 70.

As illustrated in FIG. 8, surfaces of the distal ends 52A of the support projections 52 are welded to the holding section 12B of each electrode surface 12A. Two joints 70 are formed such that the joints 70 are aligned with the corresponding positioning boss 20 that are between the joints 70.

In the laser application areas, if distances between the linear hole edge sections 41S and the peripheries 20R of the respective positioning bosses 20 are within a range for the laser welding, the surfaces of the liner hole edge sections 41S are welded to the peripheries 20R of the respective positioning bosses 20. Through the welding, the supplemental joints 60 are formed. As illustrated in FIG. 8, the supplemental joints 60 and the joints 70 are aligned in the right-left direction.

The power storage component module 1 includes the first power storage component 10, the second power storage component 110, and the bus bar 30. The first power storage component 10 and the second power storage component 110 are disposed with the electrodes 12 on the upper side. The bus bar 30 connects the first power storage component 10 and the second power storage component 110 together. The first power storage component 10 includes the positioning boss 20 that protrudes upward from the electrode 12. The bus bar 30 includes the through hole 40 that opens in the top-bottom direction and through which the positioning boss 20 is passed. The bus bar 30 includes the support projection 52 that projects downward. The support projection 52 is disposed on the electrode 12 of the first power storage component 10. The joint 70 is provided between the support projection 52 and the electrode 12 of the first power storage component 10. The joint 70 electrically connects the support projection 52 to the first power storage component 10. The joint 70 and the positioning boss 20 are aligned when viewed from above.

According to the configuration, the bus bar 30 is positioned relative to the positioning boss 20 when the positioning boss 20 is passed through the through hole 40 and the support projection 52 is disposed on the electrode 12. With the support projection 52, the bus bar 30 tilts due to its own weight and contacts the electrodes 12. Even if a difference is present between the vertical position of the electrode 12 and the vertical position of the electrode of the second power storage component 110, the bus bar 30 is disposed on the electrodes 12 at an angle regardless of the difference. According to the configuration, the bus bar 30 is less likely to deform and thus the durability of the bus bar 30 is ensured. Further, the joints 70 are aligned with the positioning bosses 20. Therefore, the positions of the joints 70 are determined based on the positioning bosses 20.

The support projections 52 include the distal ends 52A that are aligned with the positioning bosses 20. The electrodes 12 include the holding sections 12B on which the distal ends 52A are placed. The joints 70 include the distal ends 52A and the holding sections 12B.

According to the configuration, to form the joints 70, the positions of the distal ends 52A and the holding sections 12B are determined based on the positioning bosses 20 and portions in which the joints 70 are to be formed are defined based on the positions.

The distal ends 52A are linear. The V-shaped grooves 51 including the groove bottoms 51A that are linear are formed in the upper surface over the support projections 52. Each V-shaped groove 51 is recessed to form the V-shape when viewed from a side. The groove bottoms 51A overlap the respective distal ends 52A in the top-bottom direction.

According to the configuration, a position 2051A of each distal end 52A can be determined from above based on detection of the corresponding groove bottom 51A from above. Therefore, the portion in which the corresponding joint is to be formed can be determined as a liner portion, that is, an area in which joint forming is performed can be reduced. Further, the V-shaped grooves 51 and the support projections 52 are formed by bending the bus bar 30 so that the distal ends 52A project downward. This reduces a processing cost.

### Second Embodiment

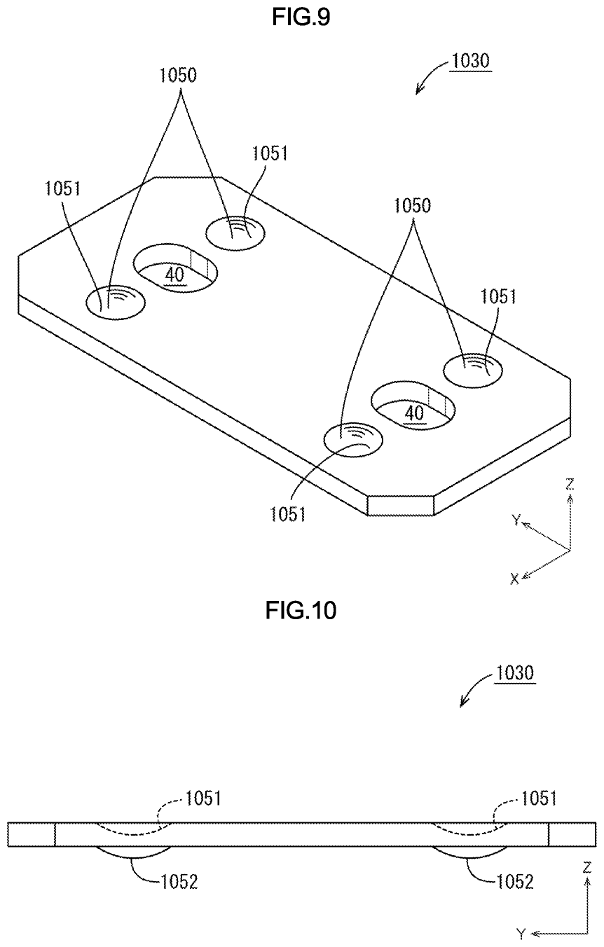

Next, a second embodiment will be described with reference to FIGS. 9 to 13. This embodiment includes a power storage component module 1001 that includes a bus bar 1030 having a configuration different from the configuration of the bus bar in the first embodiment. Components and portions corresponding to those of the first embodiment may be indicated by symbols with 1000 added to the symbols that indicate the components and the portions in the first embodiment. Configurations, functions, and effects similar to those of the first embodiment will not be described. Components and portions that are the same as the first embodiment may be indicated by the symbols used for the first embodiment.

As illustrated in FIGS. 9 to 11, the bus bar 1030 in this embodiment includes recesses 1050 instead of the bent portions 50 of the bus bar 30 in the first embodiment. Two of the recesses 1050 are provided for each through hole 40 such that the recesses 1050 are on the right and the left of the through hole 40. The recesses 1050 include support projections 1052 that project downward from a lower surface of the bus bar 1030. Each support projection 1052 has a spherical dome shape. The recesses 1050 include spherical dome recesses 1051 in an upper surface of the bus bar 1030. As illustrated in FIG. 10, each spherical dome recess 1051 has a spherical dome shape that is concentric with the support projection 1052.

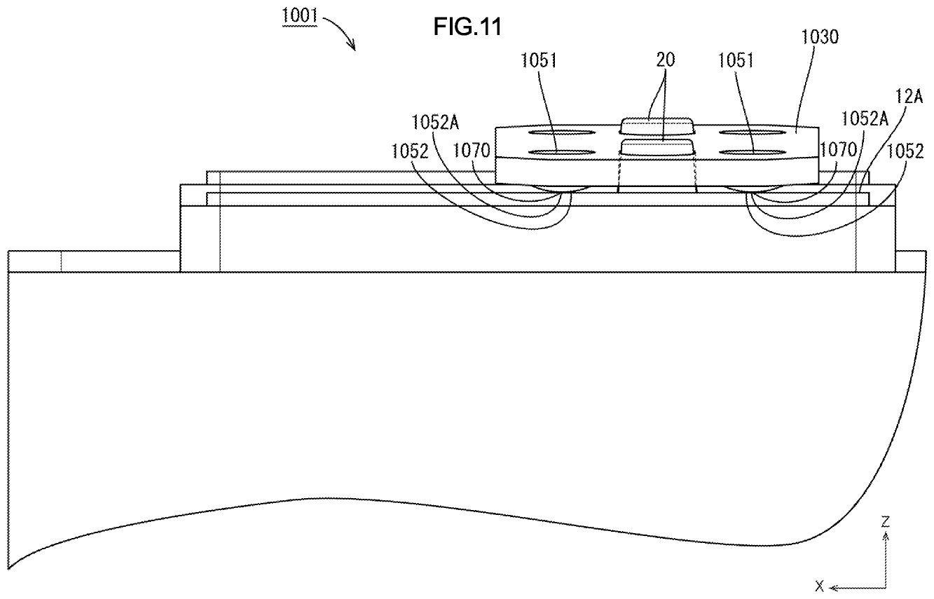

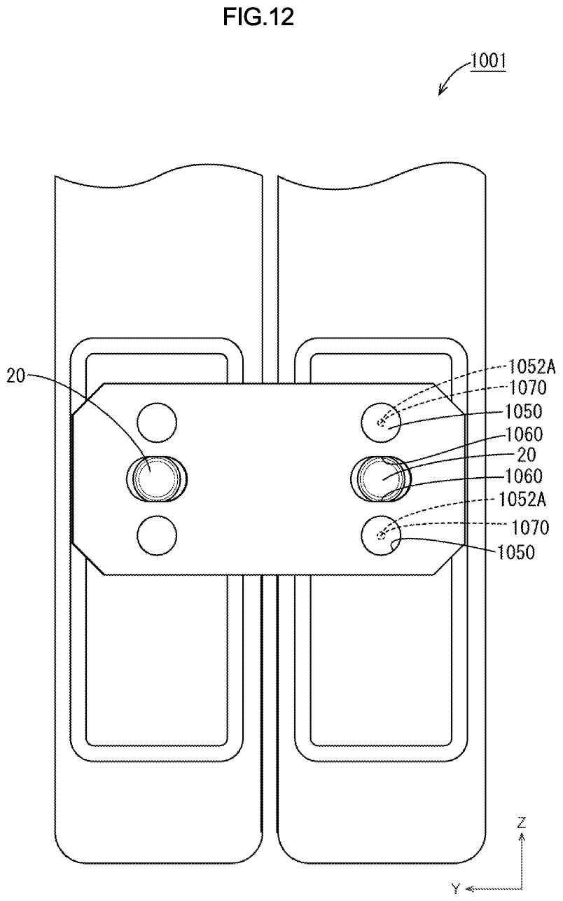

When the power storage components 10 and 110 are connected by the bus bar 1030, as illustrated in FIGS. 11 and 12, the support projections 1052 on the right and the left are disposed on the electrode surfaces 12A with the distal ends 1052A in contact with the electrode surfaces 12A on either side of the respective positioning bosses 20. Two joints 1070 are aligned with the corresponding positioning boss 20 with the corresponding positioning boss 20 between the joints 1070.

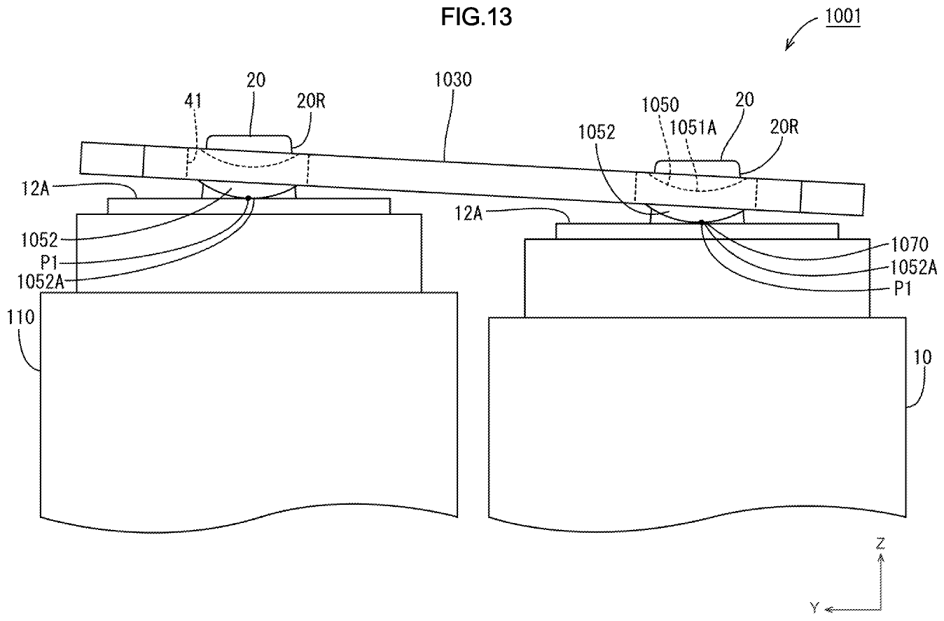

As illustrated in FIG. 13, the bus bar 30 is sloped downward toward the rear over the electrode surfaces 12A. As illustrated in FIG. 13, the recesses 1050 contact the electrode surfaces 12A with the lowest portions (i.e., the distal ends 1052A) of the recesses 1050 more to the rear than centers P1 of lower surfaces of the corresponding recesses 1050. In this embodiment, each distal end 1052A is movable in the front-rear direction with the center P1 as a center of movement in response to an angle of the bus bar 1030 relative to the corresponding electrode surface 12A.

To form each joint 1070, the lowest portion of the spherical dome recess 1051 is detected by measuring from above and the lowest portion is defined as a recess bottom 1051A (see FIG. 13). A small circular area having the recess bottom 1051A as a center is defined as a laser application area. Laser spotlight is applied to the laser application area. As illustrated in FIGS. 12 and 13, each joint 1070 is formed. Each spherical dome recess 1051 is concentric with the corresponding support projection 1052. Therefore, the position of the distal end 1052A is vertically aligned with the lowest portion (the recess bottom 1051A) of the spherical dome recess 1051. It is not necessary to set the laser application area with a margin in consideration of the positional difference.

According to the configuration, the distal end 1052A of each support projection 1052 has a small circular shape and thus the laser application area is further limited to a smaller area. The distal end 1052A of each support projection 1052 overlaps the corresponding recess bottom 1051A in the top-bottom direction. Because the distal end 1052A of each support projection 1052 overlap the corresponding recess bottom 1051A in the top-bottom direction, the corresponding joint 1070 is properly formed through application of the laser spotlight to the laser application area.

### Third Embodiment

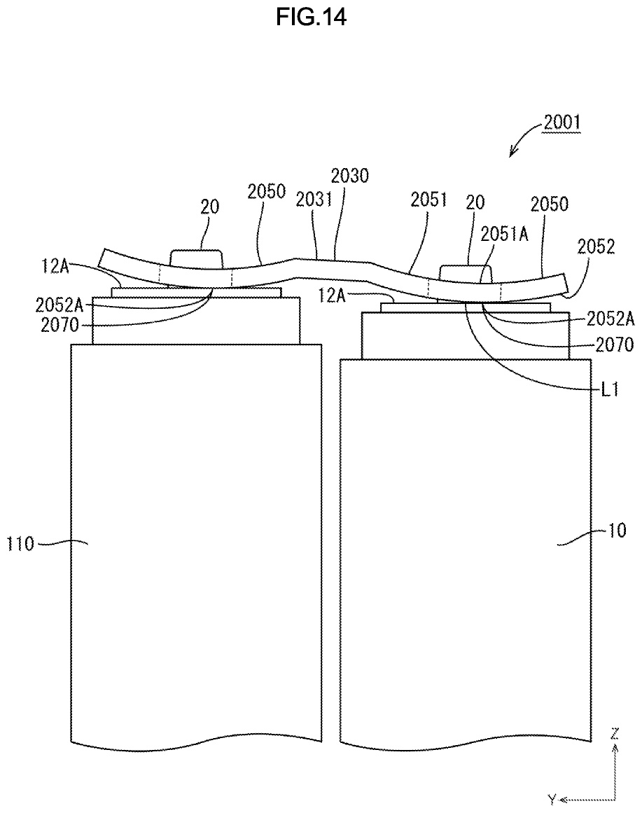

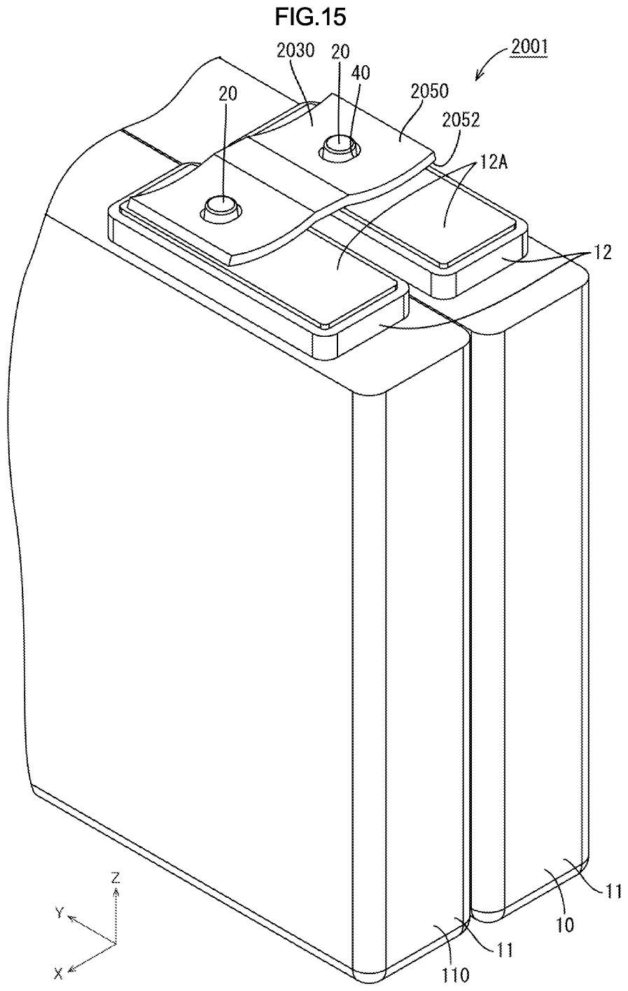

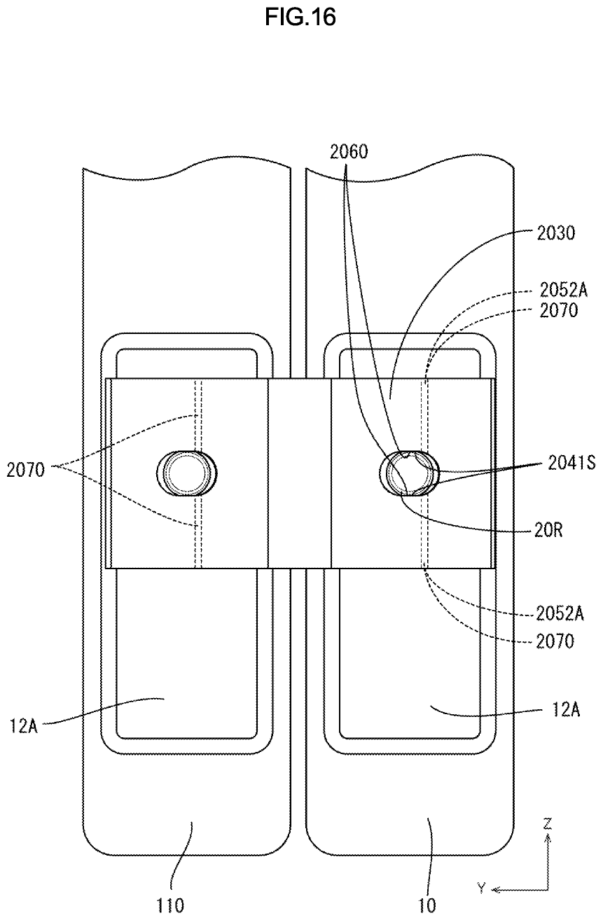

A third embodiment will be described with reference to FIGS. 14 to 16. This embodiment includes a power storage component module 2001 that includes a bus bar 2030 having configuration different from the configuration of the bus bar in the first embodiment. Components and portions corresponding to those of the first embodiment may be indicated by symbols with 2000 added to the symbols that indicate the components and the portions in the first embodiment. Configurations, functions, and effects similar to those of the first embodiment will not be described. Components and portions that are the same as the first embodiment may be indicated by the symbols used for the first embodiment.

As illustrated in FIG. 14, the bus bar 2030 in this embodiment includes support projections 2052. Each support projection 2052 has an arc shape that projects downward when viewed from a side. The bus bar 2030 includes round recesses 2051 in an upper surface over the support projections 2052, respectively. Each round recess 2051 is recessed downward such that an arc of the round recess 2051 in a side view is concentric with an arc of the corresponding support projection 2052.

According to the configuration, a distal end 2052A of each support projection 2052 is movable in the front-rear direction with a center line L1 of the support projection 2052 at the middle in the front-rear direction as a center of movement in response to an angle of the bus bar 2030. Further, the distal end 2052A of each support projection 2052 is vertically aligned with the lowest position 2051A of the corresponding round recess 2051. It is not necessary to set the laser application area with margins in the front-rear direction in consideration of the positional difference.

### Other Embodiments

The technology disclosed herein is not limited to the embodiments described above and illustrated in the drawings. For example, the following embodiments will be included in the technical scope of the technology.

(1) In the above embodiment, each positioning boss 20 has the truncated cone shape with the diameter that slightly decreases from the base end 20B toward the upper end 20D. However, the shape of the positioning bosses is not limited to the truncated cone shape. For example, each positioning boss may have a round columnar shape with a constant diameter from a base end toward an upper end.

(2) In the above embodiment, the positioning bosses 20 are disposed on the electrodes 12 of the power storage components 10 and 110 and the bus bar 30 includes the through holes 40. However, a configuration that includes a positioning boss disposed on one of power storage components and a bus bar including a single through hole may be included in the technical scope. With such a configuration, a position at which a joint is formed may be determined based on detection of a position of a distal end of a support projection from above or the positioning boss.

(3) In the above embodiment, the surface of the distal end 52A of each support projection 52 is welded to the holding section 12B of the corresponding electrode surface 12A to form the joint through the laser welding. However, the joint may be formed by placing a joining material such as a silver-based filler and a solder between the distal end and the holding section and forming the joint through brazing.

### EXPLANATION OF SYMBOLS

1, 1001, 2001: Power storage component module
10: First power storage component
12: Electrode
12B: Holding section
20: Positioning boss
30, 1030, 2030: Bus bar
40: Through hole
51: V-shaped groove
51A: Groove bottom
52, 1052, 2052: Support projection
52A, 1052, 2052: Distal end
70, 1070, 2070: Joint
110: Second power storage component
1051: Spherical recess

1. A power storage component module comprising:
a first power storage component disposed with an electrode of the first power storage component facing up;
a second power storage component disposed with an electrode of the second power storage component facing up; and
a bus bar connecting the first power storage component and the second power storage component together, wherein
the first power storage component includes a positioning boss projecting upward from the electrode of the first power storage component,
the bus bar includes: a through hole opening in a top-bottom direction and through which the positioning boss is passed; and a support projection projecting downward, the support projection being disposed on the electrode of the first power storage component,
the support projection is electrically connected to the electrode of the first power storage component via a joint between the support projection and the electrode, and
the joint and the positioning boss are aligned when viewed from above.

2. The power storage component module according to claim 1, wherein
the support projection includes a distal end that is aligned with the positioning boss,
the electrode includes a holding section on which the distal end is disposed, and
the joint includes the distal end and the holding section.

3. The power storage component module according to claim 2, wherein
the distal end has a linear shape,
the bus bar includes a V-shaped groove in an upper surface of the bus bar over the supporting projection,
the V-shaped groove is recessed to form a V shape when viewed from a side,
the V-shaped groove includes a groove bottom having a linear shape, and
the groove bottom overlaps the distal end in the top-bottom direction.

4. The power storage component module according to claim 2, wherein
the support projection has a spherical dome shape,
the support projection includes a spherical dome recess having a spherical shape in an upper surface of the bus bar, and
the spherical dome recess is concentric with the support projection.
